(19) United States
(12) Patent Application Publication
(10) Pub. No.: US 2025/0003250 A1
(43) Pub. Date: Jan. 2, 2025

(54) VEHICLE ROOF TOP TENT

(71) Applicant: FCA US LLC, Auburn Hills, MI (US)

(72) Inventor: Stephen A Sharples, Northville, MI (US)

(21) Appl. No.: 18/345,402

(22) Filed: Jun. 30, 2023

(51) Int. Cl. E04H 15/06; E04H 15/32; E04H 15/46; E04H 15/54; E04H 15/58

(52) U.S. Cl. CPC E04H 15/06; E04H 15/322; E04H 15/46; E04H 15/54; E04H 15/58; E04H 15/16

(57) ABSTRACT

In at least some implementations, a vehicle contains a roof that covers a portion of an interior of the vehicle. The roof may include one or more removable roof panel(s) that can be removably installed in an opening to the roof to selectively close the opening. The roof may also have one or more connection point(s) at which the removable roof panel(s) are coupled to the roof. A tent is configured to mount to a roof and has a base, a cover releasably coupled to the base, tent walls connected between the cover and the base, and multiple connection members by which the base is releasably coupled to the roof, wherein one or more of the connection members are releasably coupled to one or more of the connection points.

### FIELD

The present disclosure relates to a tent mountable on a vehicle roof.

### BACKGROUND

Traditionally in overland camping, tents may be mounted to vehicle roofs utilizing roof racks. These roof racks sit on top of a vehicle roof preventing access to the tent from within the vehicle's interior, and the roof racks and tent are heavy, and the roof rack causes the tent to be positioned higher relative to the vehicle which can increase air resistance and decrease fuel economy, and raise the center of mass and decrease stability of the vehicle, when the vehicle is moving.

### SUMMARY

In at least some implementations, a vehicle contains a roof that covers a portion of an interior of the vehicle. The roof may include one or more removable roof panel(s) that can be removably installed in an opening to the roof to selectively close the opening. The roof may also have one or more connection point(s) at which the removable roof panel(s) are coupled to the roof. A tent is configured to mount to a roof and has a base, a cover releasably coupled to the base, tent walls connected between the cover and the base, and multiple connection members by which the base is releasably coupled to the roof, wherein one or more of the connection members are releasably coupled to one or more of the connection points.

In at least some implementations, the cover that can move relative to the base from a stowed position to a deployed position. In the stowed position, the cover is coupled to the base with the tent walls received within a shell defined as the space between the coupled together cover and base. In the deployed position, the cover is spaced from the base and the tent walls extend between the cover and the base.

In at least some implementations, the tent includes a biasing member coupled to the cover, base, and tent walls that is received within the interior of the shell and biases the cover away from the base.

In at least some implementations, the vehicle with the tent includes an awning and one or more awning support arm(s) connected to the base for movement relative to the base. In at least some implementations, the awning and the awning support arm(s) are received within the enclosure of the shell in the stowed position, and extend outwardly from the base in the deployed position. In at least some implementations, the awning support arm(s) rotate about a rotational axis that is fixed to the tent to deploy the awning.

In at least some implementations, a floor is cantilevered to the tent and extends beyond the vehicle's roof in a direction coplanar with the base.

In at least some implementations, the cover is releasably secured to the base by a connection member that is accessible within the interior of the shell.

In at least some implementations, the tent contains an interior access port aligned with the vehicle for access to the tent from inside of the vehicle. In at least some implementations, the interior access port aligns with an opening in the vehicle's roof left by removal of one or more of the removable roof panel(s). In at least some implementations, the tent contains an exterior access port spaced away from the vehicle for access to the tent from outside of the vehicle.

In at least some implementations, the tent has a tent electrical system that is connected to either an energy storage system of the vehicle or a tent energy storage system. In at least some implementations, the energy storage system or the tent energy storage system is powered by an energy conversion system or an external power source. In at least some implementations, the tent electrical system is capable of powering vehicle accessories or tent accessories.

In at least some implementations, a tent has a base that defines the bottom of the tent and is configured to rest on top of a vehicle's roof. The tent has a cover that encapsulates the top of the tent and is releasably connected to the base. The tent has tent walls connecting the base to the cover, the tent having a stowed position wherein the cover is coupled to the base enclosing the tent walls. Additionally, the tent has a deployed position wherein the cover is released and spaced from the base exposing the tent walls between the cover and the base. The tent also may include one or more connection member(s) adapted to connect to connection point(s) of a vehicle when one or more removable roof panel(s) are removed from the vehicle and an opening in the base that at least partially aligns with an opening in the roof left by a removable roof panel when removed from the vehicle.

In at least some implementations, the tent has an awning that deploys from the base, cover, or shell to overhang an area outside of the base, cover, shell, or vehicle.

In at least some implementations, the tent in its deployed position has a floor that extends past the boundary of the cover or base and is coplanar with the base.

In at least some implementations, when the cover is released from the base, the cover is yieldably biased by a biasing member away from the base.

In at least some implementations, the tent includes a tent electrical system that is capable of powering vehicle accessories or tent accessories. In at least some implementations, the tent electrical system is either connected to an energy conversion system, an energy storage system, or an external power source.

The tent can be utilized in camping, providing temporary or long-term accommodations for users that can be accessed from within the interior of the vehicle or from the exterior. The tent may be secured directly to the roof of a vehicle without requiring a separate roof rack on the vehicle roof. This reduces weight, can reduce the height of the tent in a stowed position, which can improve vehicle handling and fuel economy, and can simplify the connection of the tent to the vehicle. Further, by enabling the tent to be connected to the vehicle over an opening left by one or more removed roof panels, the tent interior may be accessed within the vehicle. This eliminates the need for a user to leave their vehicle to enter the tent.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a side view of a vehicle including a roof top tent assembly shown in a stowed position;

FIG. 2 is a front perspective view of the vehicle with the tent assembly shown partially deployed to an intermediate position during the process of deploying the tent;

FIG. 3 is a front perspective view of the vehicle with the tent assembly shown in a deployed position;

FIG. 4 is a side view of the vehicle with the tent assembly shown in the deployed position;

FIG. 5 is a front view of the vehicle with the tent assembly shown in the deployed position;

FIG. 6 is perspective view of a vehicle with the tent assembly removed and showing removable roof panels of the vehicle;

FIG. 7 is a partial perspective view of an interior of the vehicle roof;

FIG. 8 is a bottom view of the tent base;

FIG. 9 is a side view of the vehicle with the tent assembly disconnected from the vehicle roof;

FIG. 10 is a partial side view of the vehicle showing connectors of the tent coupled to a drip rail of the vehicle;

FIG. 11 is a perspective view of the vehicle with a cover of the tent removed to show the interior of the tent;

FIG. 12 is a perspective view of the vehicle with an awning deployed and with a cover of the tent shown transparent;

FIG. 13 is a rear view of the vehicle showing a tent assembly in a deployed position;

FIG. 14 is a side view of the vehicle and tent of FIG. 13; and

FIG. 15 is a side view of the vehicle shown with awning walls extending from the awning.

### DETAILED DESCRIPTION

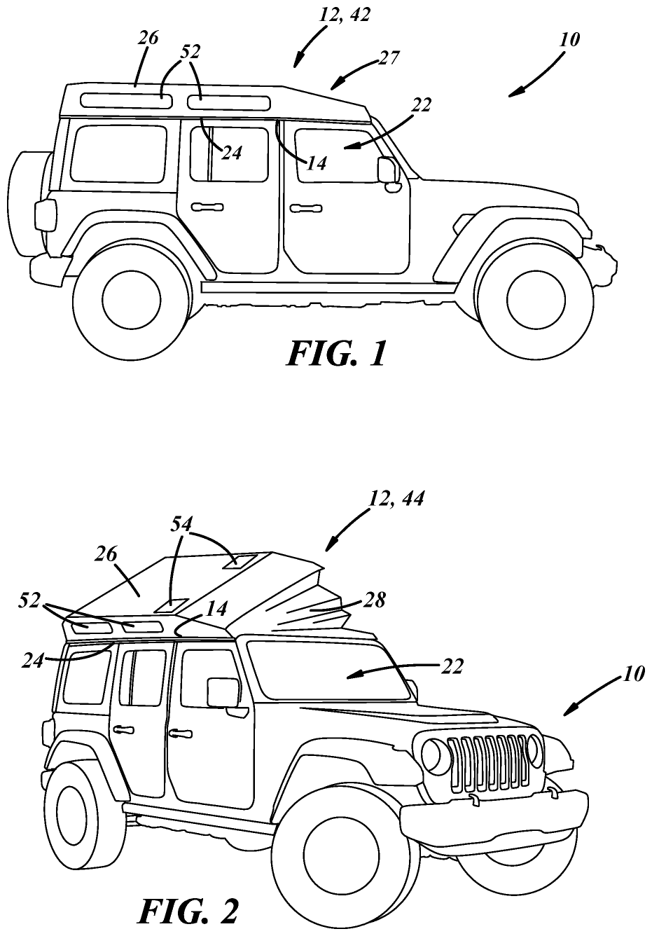

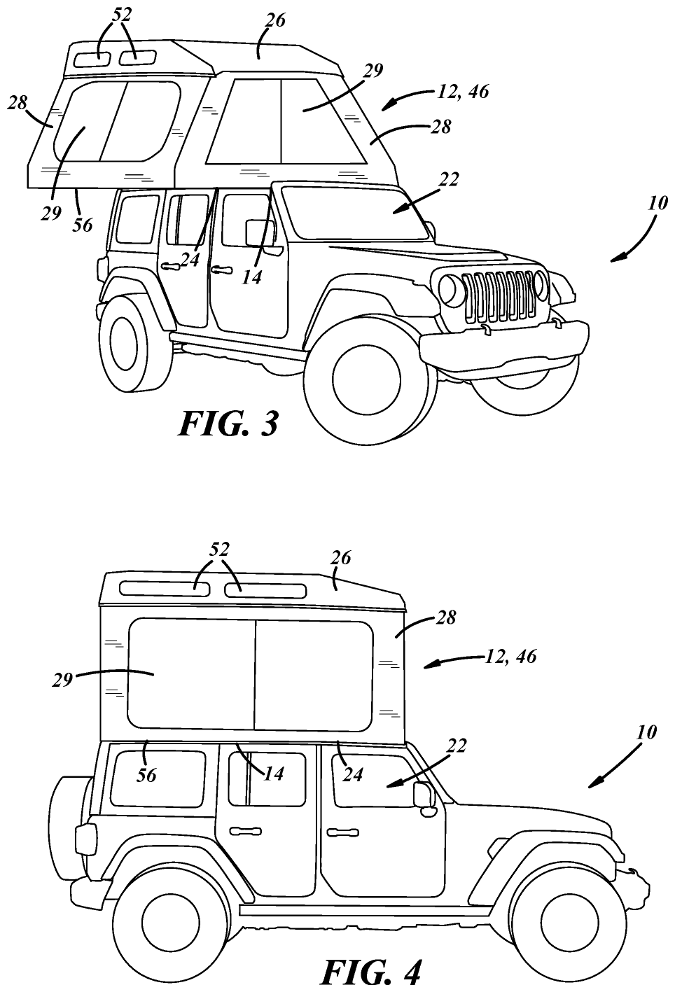

Referring in more detail to the drawings, FIGS. 1-5 and 9-14 show a vehicle 10 with a tent assembly 12 mounted to the vehicle 10. As set forth more fully below, the tent 12 may be coupled to the vehicle roof 14 and may be moved from a stowed position 42, shown in FIG. 1, to a deployed position 46, shown in FIGS. 3-5 and 13-15. So configured, the tent 12 may be stored and used on the vehicle 10 providing a convenient camping environment without consuming interior vehicle cargo space.

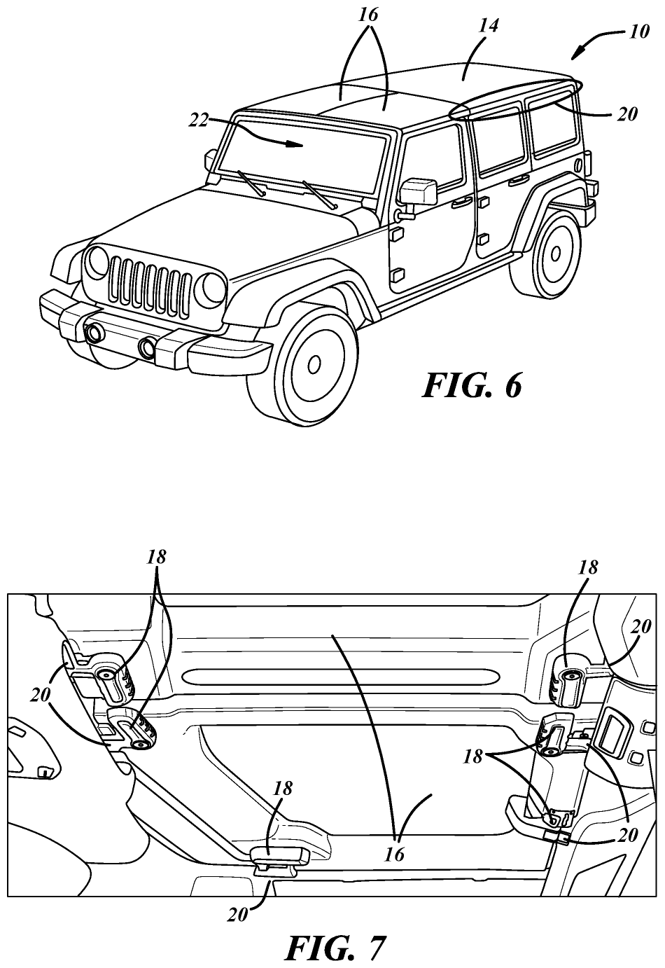

The vehicle 10 has a roof 14 that may include one or more removable roof panel(s) 16 (shown in FIGS. 6 and 7) designed to be removably coupled to the roof 14 and may be installed in an opening of the roof to selectively close the opening. The roof 14 covering at least a portion of an interior 22 of the vehicle 10. The removable roof panel(s) 16 have one or more first connection member(s) 18 and the roof 14 has one or more connection point(s) 20 at which the removable roof panel(s) 16 are coupled to the roof 14. The first connection member(s) 18 and the connection point(s) 20 are configured to be releasably coupled to each other, such that the removable roof panel(s) 16 can be releasably secured to the roof 14. In some embodiments, the interaction includes one or more of the connection member(s) 18 releasably secured to one or more of the connection point(s) 20, similar to the interaction of a latch, clamp, or bolt system among others.

The roof 14 may contain additional connection point(s) 20 that may be spaced from and not designed to be releasably coupled to the removable roof panel(s) 16. These connection point(s) 20 may be configured to be releasably coupled to second connection member(s) 19 of the tent 12 to help releasably secure the tent assembly 12 to the roof 14 as will be described in more detail later.

The vehicle 10 also contains an interior 22 that is underneath and at least partially covered by the roof 14 and is designed to accommodate a driver, passengers, and cargo. The interior 22 of the vehicle 10 may be defined in part by doors that provide access to the interior 22. Removal of one or more of the removable roof panel(s) 16 provides an opening through the roof 14 and into the interior 22.

A vehicle electrical system is contained within the vehicle 10 that contains an energy storage system, an energy conversion system 86, and energy ports. The energy storage system is a system utilized to store energy temporarily such as a battery. The energy conversion system 86 is utilized to convert energy from other forms such as motion or solar energy to electrical charge that can be stored within the energy storage system, thus powering the energy storage system. In some embodiments, the energy conversion system 86 may be an alternator that is driven by an engine powering the vehicle 10 to convert the rotational motion of the engine into electrical charge that can be used by vehicle systems when the engine is running, and that can be stored in a vehicle's battery. In other embodiments, the energy conversion system 86 may consist of a solar panel that converts solar energy to electrical charge that can be stored in a battery. Electronics such as computers and accessories may receive power from the energy storage system. Electrical ports/outlets may be provided throughout the interior 22 of the vehicle 10 or the interior of the tent, allowing electricity to be transferred from the energy storage system to power external accessories. External accessories may include, for example, personal electronics such as navigation systems, radar detectors, mobile phones, personal computers, portable air compressors, televisions, radios, lights, etc. Some such accessories may be accessible and used within the tent, when it is deployed for use.

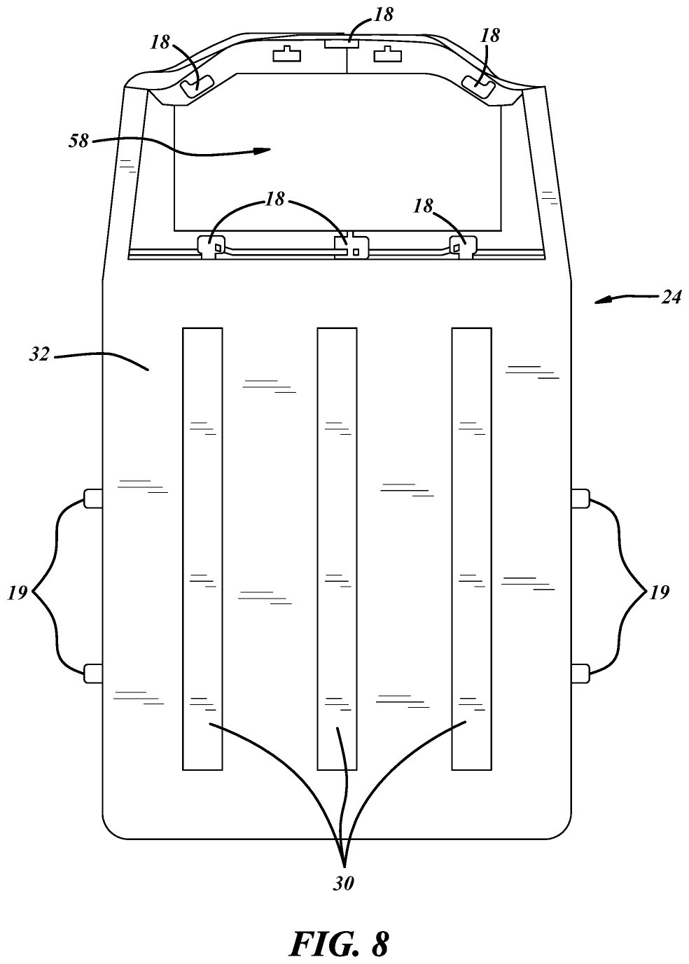

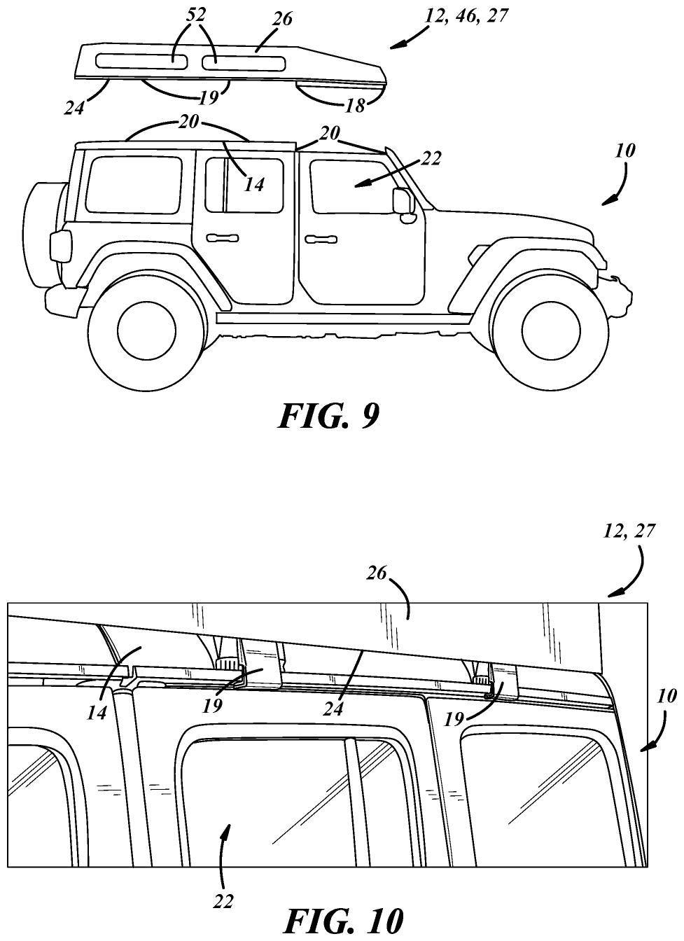

The tent 12 is designed to be mounted on the roof 14 of the vehicle 10. The tent 12 includes a base 24, a cover 26 releasably coupled to the base 24, and tent wall(s) 28 connected between the base 24 and cover 26, with an interior of the tent 12 defined between the base 24, cover 26 and tent walls 28. The base 24 defines the bottom of the tent 12 and is configured to rest on top of a vehicle's roof 14. An interior surface of the base 24 may define a lower surface or floor 56 of the tent interior 57. To retain the tent 12 on the vehicle 10, the base 24 is releasably coupled to the roof 14. To connect the base 24 to the roof 14, the base 24 may include connection member(s) 18, 19 (shown e.g. in FIGS. 8 and 9) that are designed to be releasably coupled to connection point(s) 20 on the roof 14. More specifically, in at least some implementations, when the removable roof panel(s) 16 are removed from the vehicle 10, one or more of first connection member(s) 18 of the base are configured to be releasably coupled to the same connection point(s) 20 that the removable roof panel(s) 16 are designed to be releasably coupled to. In this way, the first connection members 18 may be constructed like the corresponding connection members of the removable roof panels 16, and may connect to the roof 14 in the same way as the connection members of the removable roof panels 16. One or more connection members(s) 18 adapted to connect to connection point(s) 20 of a vehicle 10 when one or more removable roof panel(s) 16 are removed from the vehicle 10. The base 24 may also include second connection member(s) 19 that are designed to be releasably coupled to the additional connection point(s) 20 on the roof 14 that are spaced from and that do not interact with area of the roof 14 associated with the removable roof panel(s) 16. Furthermore, the base 24 may include padding 30 on a bottom surface 32 to reduce vibrations between the base 24 and the roof 14 and to prevent abrasive damage to either the base 24 or the roof 14.

In the stowed position 42 of the tent 12, the cover 26 is coupled to the base 24 and the tent walls 28 are received within a shell 27 defined by the base 24 and cover 26. The cover 26 defines the top of the tent 12 and is releasably connected to the base 24. In the example shown, the cover 26 includes a main wall that defines the top of the tent 12 and an upper surface of the cover 26, and depending sidewalls connected at one end to the main wall and extending to a free edge received adjacent to or on the base 24 when the cover 26 is coupled to the base 24. The sidewalls may extend from opposite sides of the main wall and from the front and rear of the main wall. While the cover 26 is shown as including the sidewalls, the sidewalls could be carried by or connected to the base 24 or a combination of the base 24 and cover 26, as desired. the cover 26 can move relative to the base 24 from a stowed position 42 coupled to the base 24 with the tent walls 28 received within a shell 27 defined between the coupled together cover 26 and base 24 to a deployed position 46 wherein the cover 26 is spaced from the base 24, exposing the tent walls 28 between the cover 26 and the base 24.

The cover 26 may contain cover window(s) 52, consisting of transparent or translucent sections within the cover 26 allowing light to pass into the cover 26. In at least some embodiments, this section is made of a polymer or composite material although it would be possible to use any other material with transparent or translucent properties. In some embodiments, cover window(s) 52 are located on side portions of the cover 26, however, one skilled in the art would recognize that other locations on the cover 26 may be suitable for cover window(s) 52. Furthermore, the cover 26 may contain one or more vent(s) 54 to draw air from outside of the tent to within the inside of the tent 12 or to extract air from the inside of the tent 12 to outside of the tent 12. The vent(s) 54 may be accompanied by one or more vent fan(s). Vent fan(s) are powered machine(s) used to create a flow of air increasing air circulation, and temperature control of the inside of the tent 12.

The cover 26 is releasably coupled to the base 24 by one or more connection members that may include one or more latches, clamps, fasteners, clips or the like and is accessible from within the shell. A water tight seal may be provided between the base and cover when they are connected together to prevent water and contaminants from entering the enclosure in use of the vehicle. When the connection members are released, the cover 26 can move relative to the base 24 to expand or deploy the tent 12, as will be described in more detail later.

The tent wall(s) 28 are connected between the base 24 and the cover 26 at all sides of the tent 12. The tent walls 28 may be defined by any desired material, and may be flexible so that they can be folded and received between the base 24 and cover 26 in the stowed position 42 of the tent 12. The tent walls 28 may include translucent portions or windows and selectively openable panels or doors through which the interior of the tent 12 may be accessed, if desired. Support members 50 may be coupled to the tent walls 28, for example at corners or edges between adjacent walls, if desired, to provide greater rigidity to the tent walls 28 when the tent 12 is deployed. The support members 50 may be made of a flexible material or provided in folding sections to facilitate folding the tent walls 28 into the enclosure defined by the shell 27 in the stowed position 42. In some embodiments, the support members 50 may be unattached from the tent walls 28, spanning between the base 24 and cover 26. In additional embodiments, the support members 50 may be outside of the tent walls 28 outside of the tent's interior, inside of the tent walls 28 within the tent's interior, or within the tent walls 28.

In at least some implementations, the shell 27 includes one or more biasing members 36 that yieldably bias the cover 26 away from the base 24. The biasing member(s) 36 may be coupled to the base 24 and to the cover 26, and when the cover 26 is not latched/connected to the base 24, the biasing member(s) 36 may move the cover 26 relative to the base 24 away from the base 24 to facilitate moving the tent 12 to the deployed position 46. The biasing member(s) 36 may include springs or pneumatic cylinders 51, 53 or other device that provides a force tending to move the cover 26 away from the base 24, while permitting the cover 26 to be coupled to the base 24 when a force greater than the force applied by the biasing member 36 is applied to the cover 26. The biasing member 36 may be coupled to the cover 26, base 24, and tent walls 28 and may be received within the interior of the shell 27.

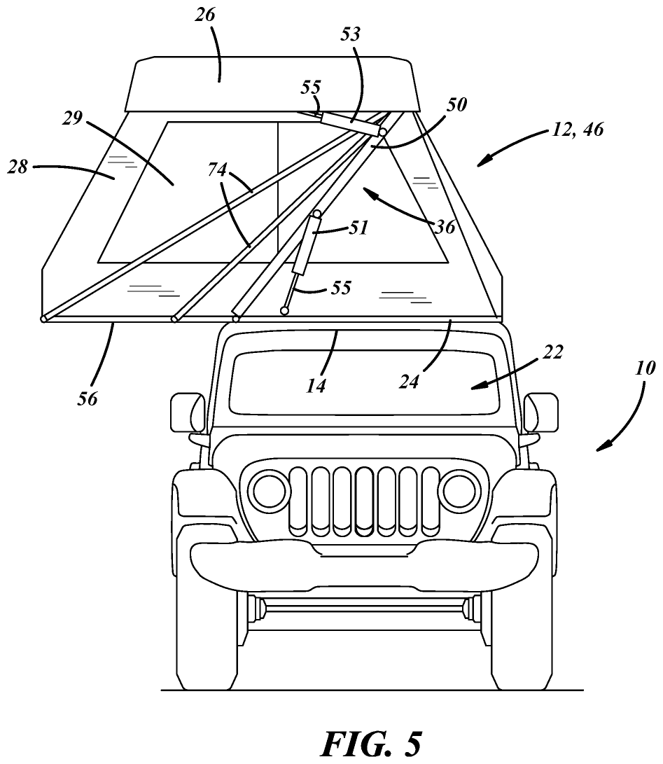

In the example shown in FIG. 5, the biasing member 36 includes a support member 50 pivotably coupled to the base 24 at one end and pivotably coupled to the cover 26 at the other end. A first pneumatic cylinder 51 with an extendable rod 55 is connected between the base 24 and the support member 50, and a second pneumatic cylinder 52 with an extendable rod 55 is connected between the cover 26 and the support member 50. When the cover 26 is latched to the base 24, the biasing member 36 is received within the interior of the shell 27. When the cover 26 is not latched to the base 24, the force of the pneumatic cylinders 51, 53 pivots the support member 50 upwardly to displace the cover 26 from the base 24 which extends and unfolds the tent walls 28. The biasing members 50 may be designed to fully displace the cover 26 away from the base 24 to the fully deployed position 46 of the tent 12, without requiring intervention by a person, or the biasing member(s) 36 may partially deploy the tent 12 with a person then moving the cover 26 to the deployed position 46 and perhaps securing one or more support members 50 in a locked, deployed position 46. More than one such biasing member 36 may be provided about the exterior of the tent 12, as desired, to balance the load and facilitate deployment of the tent 12. Further, as noted, the biasing member 36 may include other constructions and arrangements, need not use pneumatic cylinders 51, 53 and could use other driving mechanisms like springs, hydraulic cylinders, or a motorized actuator, etc.

So arranged, the tent 12 has two main positions: a stowed position 42 and a deployed position 46. In the stowed position 42, the cover 26 and the base 24 are coupled together and the tent wall(s) 28 are contained in the shell 27 defined between the cover 26 and base 24. The tent 12 can be removed from or installed onto the roof 14 when in the stowed position 42. Additionally, components and accessories of the tent 12 may be stored within the enclosure between the base 24 and cover 26 when in the stowed position 42. The tent 12 is in its most compact and low-profile orientation when in the stowed position 42, this is ideal to limit wind resistance and maintain a low center of gravity while the vehicle 10 is in motion.

When the tent 12 is in the deployed position 46, the tent wall(s) 28 are fully extended between the cover 26 and the base 24 and separate an interior of the tent 12 from the outside of the tent 12. In at least some embodiments the tent wall(s) 28 may contain several layers. For example, the tent wall(s) 28 may have windows 29 consisting of a screen material that is transparent and allows air to pass through. Thus, allowing one to view from inside the tent 12 to outside or from outside the tent 12 to inside. A privacy layer may overlay the screen material of the window 28. The privacy layer being opaque restricting the amount of light and air that can pass through the window 28. In some embodiments, an insulated layer may overlay both the window 29 and the privacy layer. The insulated layer being opaque and made of a material with insulating properties such that the insulated layer is resistant to heat transfer or noise/vibrations.

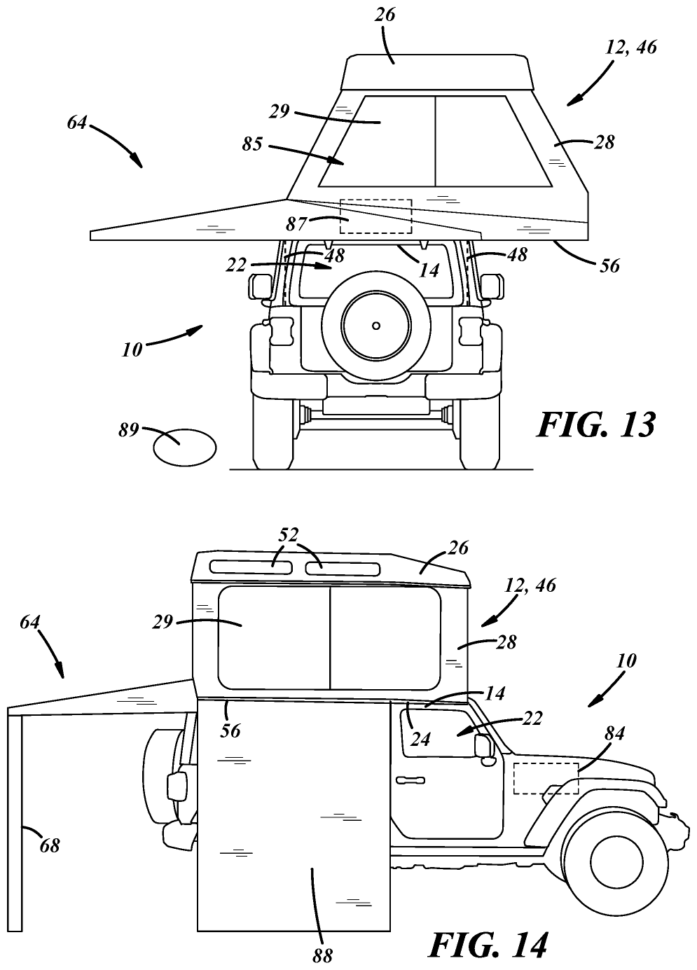

The floor 56 may be a platform held within the base 24. In some embodiments, the floor 56 may be one with the base 24 such that the top surface of the base 24 acts as the floor 56. In other embodiments, the floor 56 may be a separate component that is coupled to the top surface of the base 24. As shown in FIG. 5, the floor 56 may have a greater surface area than the base 24 or the roof 14, such that it can be cantilevered from the base 24 extending beyond the cover 26 or the base 24 in a direction coplanar with the base 24 and roof 14. In this instance, the floor 56 must be folded utilizing a hinge or similar system to place the floor 56 between the cover 26 and base 24 when the tent 12 is in the stowed position 42. In the deployed position 46, the floor 56 would be unfolded such that it overhangs beyond the roof 14 in a direction coplanar with the roof 14. In at least some embodiments, the tent 12 may have additional structure 48 to further support the roof 14 of the vehicle 10. In the embodiment shown in FIG. 13, the additional structure 48 is positioned under the roof 14, to provide additional support to the roof 14.

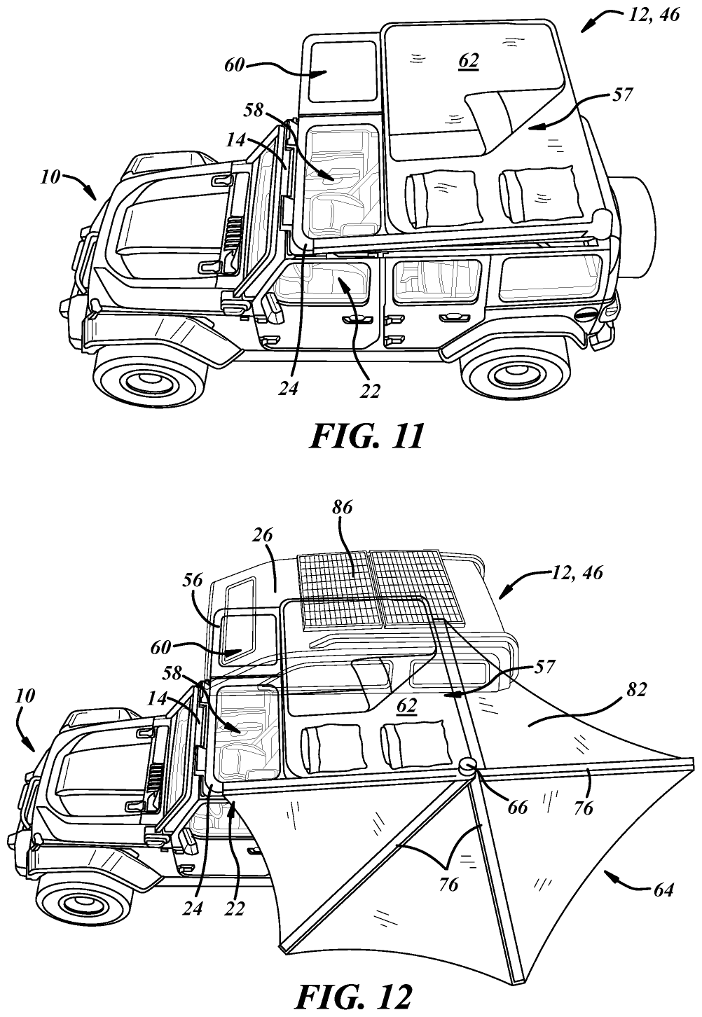

As shown in FIGS. 11-12, the floor 56 may have an interior access port 58 extending through the base 24 to the interior 22 of the vehicle 10 to allow access to the vehicle interior 22 from the tent interior 57 or allow access to the tent interior 57 from the vehicle interior 22. The interior access port 58 may be an opening in the base 24 that at least partially aligns with an opening in the roof 14 left by one or more removable roof panels when removed from the vehicle 10. The interior access port 58 is configured to generally align with the portion of the roof 14 where the removable roof panel(s) 16 would be affixed to the roof 14. The interior access port 58 is aligned with the vehicle's interior 22 for access to the tent 12 from inside of the vehicle 10. A step or similar device may be placed within the vehicle's 10 interior 22 to facilitate ease of entry to and from the tent 12 to the vehicle's 10 interior 22. Alternatively, the floor 56 may have an exterior access port 60 spaced away from the vehicle 10, for access to the tent 12 from outside of the vehicle 10. In at least some embodiments, the exterior access port 60 may extend through the floor 56. In some embodiments, the exterior access port 60 has a door with an open and closed position, allowing selective access to the inside of the tent 12 from the outside of the vehicle 10. Because the exterior access port 60 is within the floor 56 that is cantilevered from the tent 12, the exterior access port 60 is elevated off of the ground that surrounds the vehicle 10. Therefore, a ladder or similar device may be used to access the exterior access port 60 from outside of the vehicle 10 or to access the outside of the vehicle 10 from inside the tent 12. The floor 56 may also have a privacy tent 88 suspended from it, enclosing at least one side of the space between the ground surrounding the vehicle 10 and the floor 56.

As shown in FIGS. 11 and 12, bed 62 may be provided and configured to rest on the floor 56 in the tent interior 57 when the tent 12 is in the deployed position 46. In at least some embodiments, the bed 62 is an air mattress that is inflated using compressed air. The bed 62 is designed to accommodate one or more humans. In some embodiments, an air compressor is provided within the tent that is utilized to inflate the bed 62. The air compressor may utilize the energy port(s) within the interior 22 of the vehicle 10 to receive stored energy from the energy storage system 84. In other implementations, a generic air compressor may be used that is not integrated within the tent 12 and it may be powered by either an external energy source 89 or using the energy port(s) of the vehicle 10. In some embodiments, the bed 62 may be heated or cooled by a heating or cooling system that is powered by the vehicle energy storage system 84 or the tent energy storage system 87.

As shown in the embodiments represented by FIGS. 11-15, the tent 12 may also include an awning 64 that is deployable from either the base 24, the cover 26, or the shell 27 to overhang a portion of the exterior of the vehicle 10 beyond the base 24, the cover 26, or the shell 27, thus providing a covered area that is shielded from undesirable weather conditions or the sun. The awning 64 may have one or more support arms 76 that is/are connected to the base for movement relative to the base 24. The support arms 76 may rotate about a rotational axis 66 to deploy or retract the awning 64. In at least some implementations, the rotational axis 66 is fixed to the tent 12. In the example shown in FIG. 12, the awning 64 includes multiple support arms 76 and the material of the awning 64 is coupled between the support arms 76 such that the awning 64 is unfolded when the support arms 76 are rotated in a first direction relative to the base 24 and the awning 64 is folded when the support arms 76 are rotated in the opposite, second direction. In the stowed position 42, the support arms 76 may be stacked on top of each other or otherwise received within the enclosure of the shell 27, if desired. The awning material 82 may instead be connected to the base 24 and to a single support arm 76 that is moved to unfold and fold the awning 64 in a similar manner. Further, in the deployed position 46 the awning 64 may extend outwardly from the base, spanning any desired area, and in some implementations may span two-hundred and seventy degrees about the rotational axis 66, and have one support arm 76 parallel to and coupled to a side of the base 24, and another support arm 76 parallel to and coupled to the rear of the base 24, with one or more support arms 76 extending outwardly from base 24.

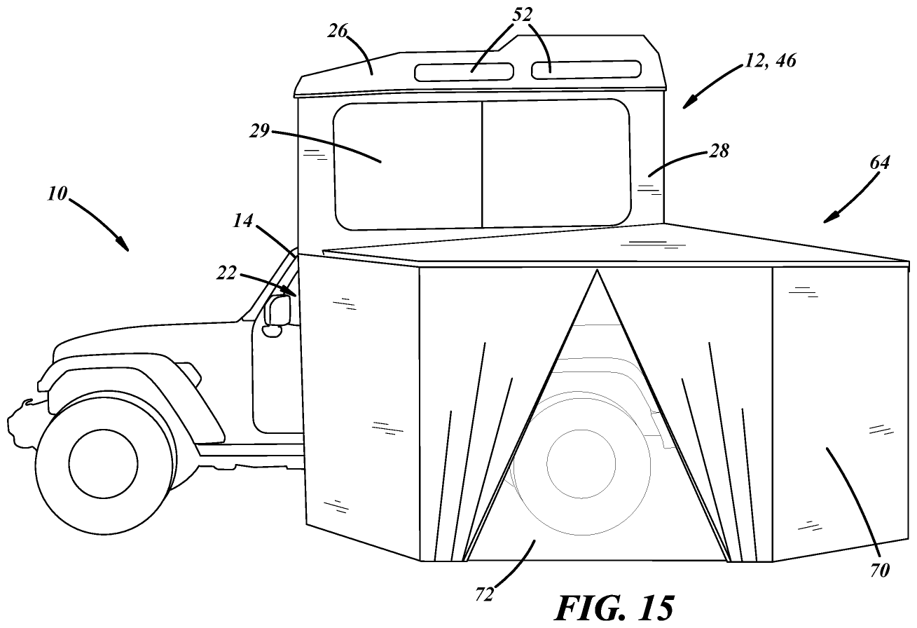

As shown in FIG. 13, the awning 64 may be self-supporting such that it is cantilevered from the tent 12 requiring no other form of support. However, as shown in FIGS. 14 and 15, one or more post(s) 68 may be added to the awning 64 to further stabilize the awning 64 in adverse weather conditions. The post(s) 68 may be adjustable in height to adapt to varying terrain height that may surround the vehicle 10 and tent 12. As shown in FIGS. 14 and 15, awning walls 70 or awning screens 72 may be attached to the awning 64 such that the awning walls 70 or screens hang from the perimeter of the awning 64, at least partially enclosing the area covered by the awning 64. The awning 64, and any awning screens 72 or walls 70 may all be configured to be stored within the enclosure of the shell 27 when the tent 12 is in its stowed position 42.

As shown in FIG. 13, the tent 12 may have a tent electrical system 85 to power tent accessories which may be part of the tent 12 or brought to the tent 12 by a user. The tent electrical system 85 is capable of powering vehicle accessories or tent accessories. Tent accessories may consist of mobile phones, interior and exterior lighting, fans, or heating or cooling systems for the bed 62. The tent electrical system 85 has a tent energy storage system 87 that may be comparatively smaller in size and output to the vehicle's energy storage system 84. The tent energy storage system 87 may consist of a battery configured to power electronics to be used within the inside of the tent 12 or around the tent 12. The tent energy storage system 87 may be powered by an energy conversion system 86. Also, the tent energy storage system 87 may be powered by cord routed, for example, through the access port into the vehicle's interior 22 to be connected to an energy port that is powered by an energy storage system 84 or an energy conversion system. Alternatively, the tent energy storage system 87 may be powered by an external power source 89 such as a power outlet or a solar panel that can be mounted on or near the cover 26 or the vehicle 10. The tent electrical system 85 may consist of energy outlets which can be mounted in or around the tent. The energy outlets supply power from the tent energy storage system 87 to the electronics being used within the inside of the tent 12 or around the tent 12. The tent electrical system 85 may also power vehicle accessories that are used with the vehicle 10. Vehicle accessories may include vehicle computer or control systems, vehicle lighting, vehicle infotainment systems, vehicle audio systems or similar electronics for use with the vehicle 10. The tent electrical system 85 may be connected to either the energy storage system 84 of the vehicle 10 or the tent energy storage system 87. The tent electrical system 84 may be connected to an energy conversion system 86, an energy storage system 84, or an external power source 89.

FIGS. 1-5 and 9-15 show the vehicle 10 with the tent 12. In FIG. 1, the tent 12 is coupled to the roof 14 of the vehicle 10 in its stowed position 42 such that the base 24 and the cover 26 are coupled together. In the stowed position 42 the tent wall(s) 28 are stored between the base 24 and cover 26. FIG. 2 shows the tent 12 in an intermediate position 44 as the tent is being deployed from the stowed position to the deployed position 46 after the cover is unlatched or disconnected from the base 24. In the intermediate position 44, one side of the cover 26 is separated from the base 24 and biased vertically by the biasing member(s) 36 pictured in FIG. 5, exposing a portion of the tent wall(s) 28. The intermediate position 44 provides access to the inside of the tent 12 through the windows 29 without fully deploying the tent 12. Allowing a user access to anything that may be stored between the base 24 and the cover 26. FIGS. 3-5 show the tent 12 in its deployed position 46, such that the base 24 and the shell 27 cover 26 are fully separated from each other, fully extending the tent wall(s) 28 between the base 24 and cover 26.

In the embodiments shown in FIGS. 3-5 and 11-15, the floor 56 unfolds from the base 24, extending past the roof 14. The floor 56 is cantilevered from the base 24, but, as shown in FIG. 5, can be supported by additional structure(s), like cables 74, extending from other components of the tent 12 like the support member 50. Cantilevering the floor 56 past the roof 14 increases the surface area of the floor 56 of the tent 12, thus increasing the potential volume of the tent 12. In at least some embodiments, the floor 56 cantilevered to the tent 12 extends beyond the vehicle's roof 14 in a direction coplanar with the base 24.

Before moving from the deployed position 46 to the stowed position 42 the portion of the floor 56 that is cantilevered from the base 24 is folded on top of or into the base 24. This will fold a portion of the tent wall(s) 28 towards the base 24 and roof 14. Next, the tent 12 can be moved toward the stowed position by unlocking the support member(s) 50 and/or the biasing member(s) 36 and pushing one side of the cover 26 towards the base 24 which will partially fold or collapse the tent walls 28. Finally, with all of the tent walls 28 between the cover 26 and base 24, the cover 26 can be pushed down onto and secured to the base 24, returning the tent 12 to the fully stowed position 42.

As shown in FIG. 9, the tent 12 can be conveniently removed or installed from the vehicle 10 while in the stowed position 42. To install the tent 12 on the vehicle 10, the removable roof panel(s) 16, as shown in FIGS. 6-7, are removed from the roof 14 by uncoupling the connection member(s) 18 of the removable roof panel(s) 16 from the connection point(s) 20 of the roof 14. Once the removable roof panel(s) 16 are removed from the roof 14, the tent 12 in its stowed position 42 can be lifted on top of the roof 14. Next the base 24 of the tent 12 and the roof 14 are aligned such that the first connection member(s) 18 of the base 24 are configured to be releasably coupled to the connection point(s) 20 of the roof 14 to which the removable roof panel(s) 16 were connected. Also, the second connection member(s) 19 designed to be releasably coupled to connection point(s) 20 of the roof 14 that are not designed to be releasably coupled to the removable roof panel(s) 16 are aligned. After alignment, the base 24 can be lowered onto the roof 14 and the connection member(s) 18, 19 can be releasably coupled to the connection point(s) 20, securing the tent 12 to the roof 14 of the vehicle.

Furthermore, FIG. 9 demonstrates preferred alignment of the base 24 and the roof 14 before the base 24 is completely lowered onto the roof 14 and the one or more connection member(s) 18 are releasably coupled to the one or more connection point(s) 20. FIG. 10 shows the connection point(s) 20 not designed to be releasably coupled to the removeable roof panel(s) 16 interacting with the connection member(s) 18 of the base 24. These are shown as including a J-shaped hook that is received over an outwardly extending rail of the roof, which may be a so-called “drip rail” that overhangs the vehicle doors and is designed to inhibit water from collecting along the top of a vehicle door to reduce water that drips into the vehicle when the doors are opened. The rail provides a surface along with clamps or hooks of the tent may be secured and tightened, to provide additional points of connection between the tent 12 and vehicle 10.

With the tent 12 secured to the vehicle 10, a user may utilize the interior access port 58 to uncouple the cover 26 from the base 24 and permit deployment of the tent 12 from the stowed position 42. For example, a user may actuate a lever or similar device to uncouple the cover 26 from the base 24 without having to do so from outside the vehicle 10. Once a portion of the cover 26 is uncoupled from the base 24, the biasing member(s) 36 may displace the cover 26 vertically, extending the cover 26 from the base 24, as noted above.

What is claimed is:

1. A vehicle comprising:
a roof covering at least a portion of an interior of the vehicle, the roof including one or more removable roof panel(s) that are removably installed in an opening of the roof to selectively close the opening, the roof having one or more connection point(s) at which the removable roof panel(s) are coupled to the roof;
a tent having a base, a cover releasably coupled to the base, tent walls connected between the cover and the base, and multiple connection members by which the base is releasably coupled to the roof, wherein one or more of the connection members are releasably coupled to one or more of the connection points.

2. The vehicle of claim 1, wherein the cover can move relative to the base from a stowed position coupled to the base with the tent walls received within a shell defined between the coupled together cover and base to a deployed position wherein the cover is spaced from the base and the tent walls extend between the cover and the base.

3. The vehicle of claim 2, wherein the tent includes a biasing member coupled to the cover, base, and tent walls that is received within the interior of the shell and biases the cover away from the base.

4. The vehicle of claim 3, wherein the tent includes an awning and one or more support arm(s) connected to the base for movement relative to the base.

5. The vehicle of claim 4, wherein the awning and the support arm(s) are received within the enclosure of the shell in the stowed position, and extend outwardly from the base in the deployed position.

6. The vehicle of claim 4, wherein the awning support arm(s) move about a rotational axis that is fixed to the tent to deploy the awning.

7. The vehicle of claim 2, wherein a floor cantilevered to the tent extends beyond the vehicle's roof in a direction coplanar with the base.

8. The vehicle of claim 2, wherein the cover is releasably coupled to the base by a connection member that is accessible within the shell.

9. The vehicle of claim 2 wherein the tent contains an interior access port aligned with the vehicle's interior for access to the tent from inside of the vehicle.

10. The vehicle of claim 2 wherein the tent contains an exterior access port spaced away from the vehicle for access to the tent from outside of the vehicle.

11. The vehicle of claim 1 wherein the tent has a tent electrical system that is connected to either an energy storage system of the vehicle or a tent energy storage system.

12. The vehicle of claim 11 wherein the energy storage system or the tent energy storage system is powered by an energy conversion system or an external power source.

13. The vehicle of claim 11, wherein the tent electrical system is capable of powering vehicle accessories or tent accessories.

14. The vehicle of claim 9, wherein the interior access port aligns with an opening in the vehicle's roof left by removal of one or more of the removable roof panel(s).

15. A tent comprising:
a base that defines the bottom of the tent and is configured to rest on top of a vehicle's roof;
a cover that defines the top of the tent and is releasably connected to the base;
tent walls connecting the base to the cover, the tent having a stowed position wherein the cover is coupled to the base receiving the tent walls, and the tent has a deployed position wherein the cover is released and spaced from the base exposing the tent walls between the cover and base;
one or more connection members(s) adapted to connect to connection point(s) of a vehicle when one or more removable roof panel(s) are removed from the vehicle; and
an opening in the base that at least partially aligns with an opening in the roof left by one or more removable roof panel(s) when removed from the vehicle.

16. The tent of claim 15, wherein an awning deploys from the base, cover, or shell to overhang an area beyond of the base, cover, shell, or vehicle.

17. The tent of claim 15, wherein, when the tent is in the deployed position, a floor extends beyond the boundary of the cover or base and is coplanar with the base.

18. The tent of claim 15, wherein when the cover is released from the base, the cover is yieldably biased by a biasing member away from the base.

19. The tent of claim 15, which also includes a tent electrical system that is capable of powering vehicle accessories or tent accessories.

20. The tent of claim 15, wherein the tent electrical system is either connected to an energy conversion system, an energy storage system, or an external power source.
